(19) United States
(12) Patent Application Publication
(10) Pub. No.: US 2015/0055947 A1
(43) Pub. Date: Feb. 26, 2015

(54) METHOD FOR QUICK AUTOMATIC REMOTE WAVELENGTH DISCOVERY AND CONFIGURATION

(71) Applicant: TELEFONAKTIEBOLAGET L M ERICSSON (PUBL), Stockholm (SE)

(72) Inventors: Ming Xia, Milpitas, CA (US); Stefan Dahlfort, Stockholm (SE); David Hood, Palo Alto, CA (US)

(73) Assignee: TELEFONAKTIEBOLAGET L M ERICSSON (PUBL), Stockholm (SE)

(21) Appl. No.: 13/974,898

(22) Filed: Aug. 23, 2013

(51) Int. Cl. H04J 14/02

(52) U.S. Cl. CPC H04J 14/0227
USPC 398/28; 398/79

(57) ABSTRACT

A remote node, e.g., a client-side node or a service-side node, writes wavelength information into an overhead message of a packet carried by an optical signal when an optical port associated with the remote node is deployed. The overhead message explicitly identifies the wavelength channel associated with the newly deployed optical port to a hub node in a WDM optical network. The hub node identifies the new wavelength channel associated with the newly deployed optical port based on the overhead message to enable the hub node to associate the new wavelength channel with the newly deployed optical port.

### TECHNICAL FIELD

The invention disclosed herein generally relates to a Wavelength Division Multiplexed (WDM) optical network, and more particularly relates to optical port discovery in WDM optical networks.

### BACKGROUND

Conventional approaches to transporting mobile, business, and residential service traffic have dedicated different parallel networks to transporting the traffic of different services. More recent approaches, by contrast, contemplate transporting the traffic of those different services together using the same network. Converging the different parallel networks into one common network in this way would prove more efficient and cost-effective.

Aggregating the traffic of multiple services at the packet level through so-called packet aggregation presents one option for realizing such a “converged” network. But while packet aggregation currently requires less hardware expense, it proves difficult to scale as traffic volume increases and involves significant complexity. Aggregating the traffic of multiple services in the optical domain, e.g., using wavelength division multiplexing (WDM), is more promising in this regard. However, one obstacle to realizing a converged WDM optical network is optical port discovery due to the limited capability of logic processing on optical signals.

One conventional solution achieves optical port discovery by iteratively subdividing, in a bifurcated fashion, a spectrum of unallocated wavelength channels, to simplify the search process associated with discovering the wavelength channel of a newly deployed optical port. Such iterative bifurcation processes, however, may take an undesirable amount of time.

### SUMMARY

The solution presented herein reduces the time required for optical port discovery by using an overhead message in an optical signal received at a hub node that explicitly identifies a new wavelength channel associated with a new optical port at a remote node, e.g., a client node or a service-side node.

A hub node in a wavelength division multiplexed (WDM) optical network according to one exemplary embodiment is configured to identify a new wavelength channel associated with a new optical port at a remote node. The hub node comprises a port discovery circuit and a wavelength controller. The port discovery circuit is configured to discover the new optical port and the associated new wavelength channel. To that end, the port discovery circuit comprises at least one receiver configured to receive an optical signal from the remote node, wherein the optical signal includes an overhead message identifying the new wavelength channel associated with the new optical port, and where the receiver includes a search controller configured to identify which of a plurality of unallocated wavelength channels comprises the new wavelength channel based on the overhead message. The wavelength controller, which is configured to associate wavelength channels with the corresponding optical ports, comprises a receiver and an allocation circuit. The receiver is configured to receive an indication of the new wavelength channel from the port discovery circuit. The allocation circuit is configured to associate the new wavelength channel with the new optical port.

An exemplary method, executed in a hub node of a wavelength division multiplexed (WDM) optical network, identifies a new wavelength channel associated with a new optical port at a remote node. The method comprises receiving an optical signal from the remote node, the optical signal including an overhead message identifying the new wavelength channel associated with the new optical port. The method further includes identifying which of a plurality of unallocated wavelength channels comprises the new wavelength channel based on the overhead message, and associating the new wavelength channel with the new optical port.

An exemplary remote node is configured for connection to a hub node in a wavelength division multiplexed (WDM) optical network 10, where the remote node comprises a packet header circuit and an optical port. The packet header circuit is configured to write wavelength information associated with a requested wavelength channel of the WDM optical network into an overhead message of packet carried by an optical signal. The optical port is configured to send the optical signal including the overhead message to the hub node to explicitly identify the requested wavelength channel to the hub node.

An exemplary method, executed in a remote node configured for connection to a hub node in a wavelength division multiplexed (WDM) optical network, comprises writing wavelength information associated with a requested wavelength channel of the WDM optical network into an overhead message of an optical signal. The method further comprises sending the optical signal including the overhead message to the hub node from an optical port of the remote node to explicitly identify the requested wavelength channel to the hub node.

### BRIEF DESCRIPTION OF THE DRAWINGS

FIG. 1 shows a block diagram of a generic tiered architecture for WDM optical networks, according to one or more embodiments.

FIG. 2 shows a block diagram of a hub node configured according to one or more embodiments, illustrated in the context of client nodes, an access subnetwork node, a hub node, and service-side nodes.

FIG. 3 shows a process diagram for a process executed at the remote node according to one or more embodiments.

FIG. 4 shows a process diagram for a process executed at the hub node according to one or more embodiments.

FIG. 5 shows a more detailed block diagram of an exemplary remote node.

FIG. 6 shows a more detailed block diagram of an exemplary hub node.

FIG. 7 shows a block diagram of the port discovery circuit of FIG. 6 according to one or more embodiments.

FIG. 8 shows a block diagram of the wavelength controller of FIG. 6 according to one or more embodiments.

FIG. 9 shows a block diagram of the wavelength selection circuit of FIG. 6 according to one or more embodiments.

FIG. 10 shows a process diagram for another exemplary process executed by the hub node according to one or more embodiments.

### DETAILED DESCRIPTION

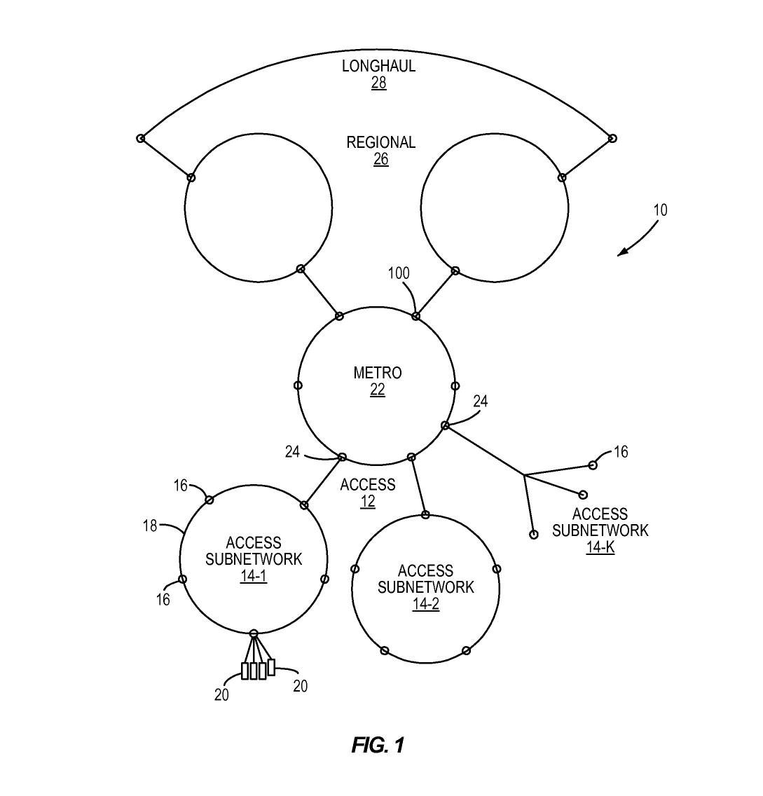

FIG. 1 shows a generic tiered architecture for a wavelength division multiplexed (WDM) optical network 10. The lowest tier shown, tier 1, includes an access network 12 comprising a plurality of access sub-networks 14-1, 14-2, . . . , 14-K. Each access sub-network 14-k is formed from multiple access sub-network nodes 16 interconnected via optical fiber 18 in a ring structure, a tree structure, a bus structure, or the like.

In general, each access sub-network node 16 communicatively connects to one or more client nodes 20, e.g., a remote radio unit, a base station, a wireless access point, or the like. Deployed at each client node 20 are one or more optical port modules that provide one or more optical ports. In some embodiments, for example, an optical port module is a hot-pluggable or hot-swappable module that is deployed at a client node 20 by being physically plugged into that client node 20. Examples of such a pluggable module include, but are not limited to, a small form-factor pluggable (SFP) transceiver module, an XFP transceiver module, etc.

Communicatively connected to one or more of the clients nodes 20, an access sub-network node 16 aggregates the wavelength channels on which those client nodes 20 transmit uplink traffic and places (i.e., adds) the aggregated wavelength channels onto the access sub-network 14 it forms. Similarly, the access sub-network node 16 drops from the access sub-network 14 the wavelength channels on which downlink traffic is transmitted to those client nodes 20. An access sub-network node 16 may therefore be appropriately referred to as an access add-drop (AAD) point.

The access network 12 in turn connects to a higher-tiered network, e.g., a metro network 22 at tier 2. The metro network 20 is formed from a plurality of interconnected central offices (COs) 24. Each CO 24 aggregates wavelength channels from one or more access sub-networks 14 to which it is connected such that the aggregated wavelength channels are “hubbed” to a hub node 100 in the metro network 22.

The hub node 100 in turn routes wavelength channels from one or more COs 24 to a higher-tiered network called the regional network 26. More specifically, the hub node 100 routes wavelength channels to an appropriate one of multiple service-side nodes (not shown), e.g., a business services edge router, a residential services or mobile services broadband network gateway (BNG), a broadband remote access server (BRAS), etc. The service-side node then routes uplink traffic from the wavelength channels (typically at the packet level) towards an appropriate destination, such as to content servicers, back towards the access networks, to the Internet, etc. Such service-side node routing may entail sending the uplink traffic to the regional network, which operates back at the optical layer. Thus, although omitted from FIG. 1 for simplicity of illustration, the hub node 100 connects to multiple service-side nodes and the service-side nodes in turn connect to the regional transport network 26.

The regional network 26 is also formed from a plurality of interconnected peer network nodes, which place the uplink traffic onto a long haul network 28 at tier 4, for inter-regional transport. Downlink traffic propagates through the networks in an analogous, but opposite, manner.

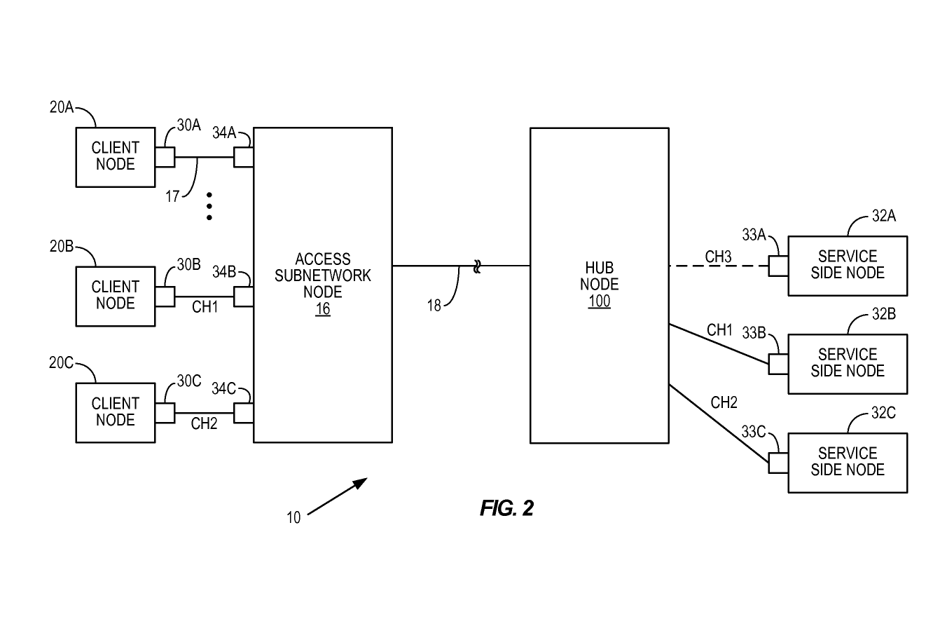

FIG. 2 shows certain nodes from FIG. 1, in a simplified context, according to one or more embodiments. Specifically, FIG. 2 shows a plurality of different client nodes 20 as client nodes 20A, 20B, and 20C. One or more optical ports 30 (shown as ports 30A, 30B, and 30C) are deployed at each client node 20. These one or more “client-side” optical ports 30 are deployed for transmitting uplink traffic towards and receiving downlink traffic from one or more “service-side” optical ports 33 (depicted as ports 33A, 33B, and 33C) deployed at one or more service-side nodes 32 (depicted as nodes 32A, 32B, and 32C). This traffic is transmitted and received via access sub-network node 16 and hub node 100.

Any given client-side optical port 30 optically transmits and receives traffic for a particular type of service (e.g., mobile, business, or residential). Moreover, predetermined attributes define how any given client-side optical port 30 transmits and receives such traffic, e.g., at a particular nominal data rate (e.g., 1 Gigabit, 10 Gigabits, 2.5 Gigabits, etc.) using a particular physical layer protocol (e.g., Ethernet, Common Public Radio Interface, etc.) and a particular line code (e.g., Carrier-Suppressed Return-to-Zero, Alternate-Phase Return-to-Zero, etc.). This means the uplink traffic transmitted by a given client-side optical port 30 must ultimately be routed to a service-side optical port 33 that has matching attributes in the sense that the service-side optical port 33 supports the particular type of service to which the uplink traffic pertains, supports the particular service provider providing that type of service, supports the particular physical layer protocol and line code with which the uplink traffic is transmitted, and the like. A client-side optical port 30 and a service-side optical port 33 that match in this sense are referred to herein as a matching pair of optical ports 30, 33. Conversely, the downlink traffic from a service-side port 33 must ultimately be routed to a client-side port 30 that matches in an analogous sense.

The hub node 100 in FIG. 2 ensures appropriate routing between optical ports 30, 33 by discovering certain attributes of client-side and service-side optical ports 30, 33 upon their deployment and forming matching pairs of optical ports, 30, 33 based on matching the discovered attributes of those ports. With a matching pair of ports 30, 33, the hub node 100 configures the routing of a wavelength channel over which those matching pairs of ports 30, 33 will eventually transmit and/or receive traffic.

FIG. 3 shows an exemplary process 300 executed by a remote noted 200 for a newly deployed optical port 220, where the remote node 200 may comprise either of the client-side node 20 and the service-side node 32. When an optical port 220 is deployed at a remote node 200, the remote node 200 writes wavelength information associated with a requested wavelength channel of the WDM optical network 10 into an overhead message of a packet carried by an optical signal (block 310). The remote node 200 sends the optical signal with the overhead message, via the newly deployed optical port 220, to the hub node 100 to explicitly identify the requested wavelength channel to the hub node 100 (block 320).

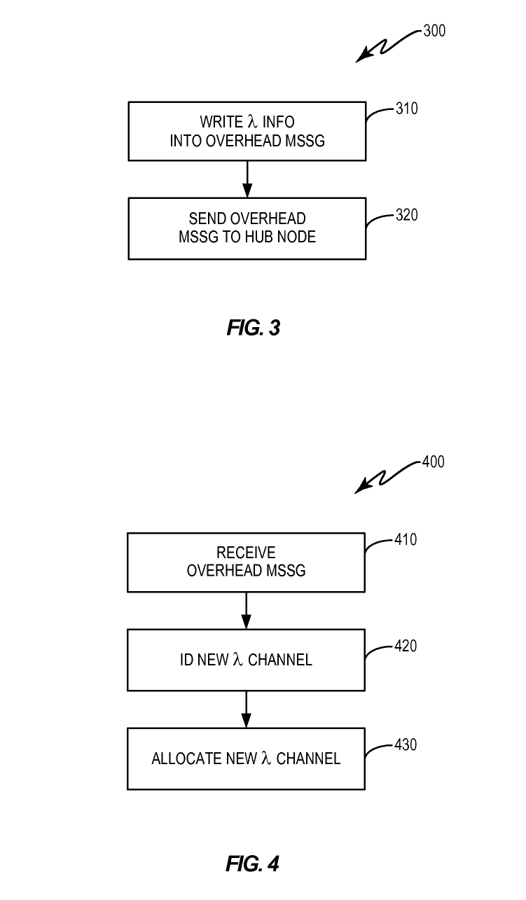

FIG. 4 shows the corresponding exemplary process 400 executed by a hub node 100 for identifying a new wavelength channel associated with the newly deployed optical port 220 at the remote node 200. The hub node 100 receives the optical signal from the remote node 200, where the optical signal includes the overhead message identifying the new wavelength channel associated with the new optical port 220 (block 410). The hub node 100 then identifies which of the unallocated wavelength channel(s) comprises the new wavelength channel based on the overhead message (block 420), and associates the new wavelength channel with the new optical port 220 (block 430). If the new optical port 220 has a matching port 30, 33 at another remote node 20, 32, the hub node 100 reroutes the identified wavelength channel to enable communication between the matching pair of ports 220 and 30 or 33.

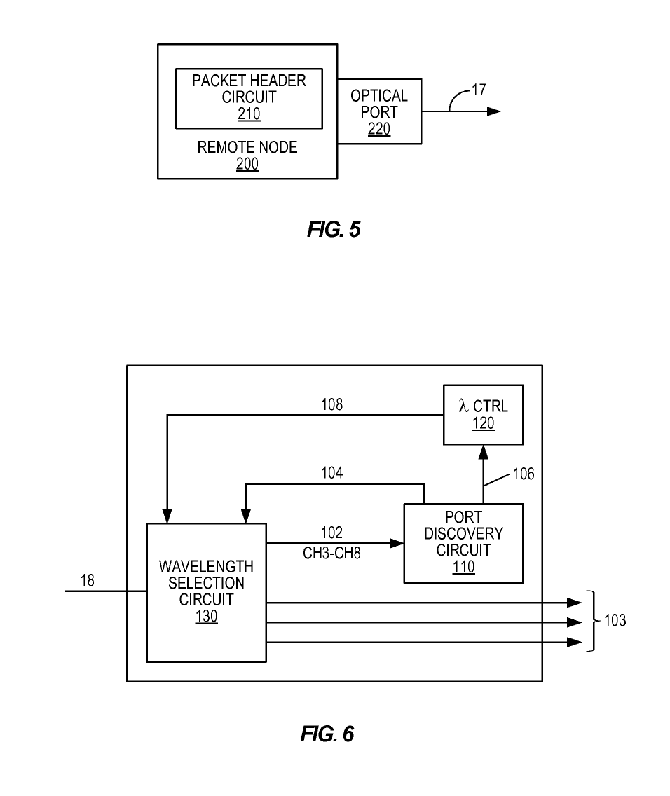

The methods 300, 400 of FIGS. 3 and 4 may be, for example, performed by the remote node 200 and hub node 100 circuits shown in FIGS. 5 and 6, respectively. FIG. 5 shows a remote node 200 comprising a packet header circuit 210. To facilitate the determination of the wavelength channel associated with a newly deployed optical port 220, the packet header circuit 210 writes wavelength information associated with a requested wavelength channel of the WDM optical network into an overhead message of a packet carried by an optical signal. For example, the packet header circuit 210 may write the overhead message into a Time Division Multiplexing (TDM) slot, an Operation, Administration, and Management (OAM) packet, an overlaid RF signal, etc. The remote node 200 then sends the optical signal, via the newly deployed optical port 220, to hub node 100 to explicitly identify the requested wavelength channel to the hub node 100.

FIG. 6 shows a hub node including a port discovery circuit 110, a wavelength controller 120, and a wavelength selection circuit 130. While FIG. 6 shows the wavelength selection circuit 130 as being part of the hub node 100, it will be appreciated that the wavelength selection circuit 130 may alternately be located remotely from the hub node 100. As depicted in FIG. 5, the remote node 200, which may comprise either of the client-side node 20 and the service-side node 32, is associated with an optical port 220 (e.g., port 30 or port 33) and includes a packet header circuit 210.

At the hub node 100, the port discovery circuit 110 searches for a new optical port 220, i.e., a port 220 newly deployed at the corresponding remote node 200. When port discovery circuit 110 detects the presence of an optical signal, the port discovery circuit 110 determines that an optical port 220 has been newly deployed at a remote node 200 to transmit or receive on a previously unallocated wavelength channel. In response, the port discovery circuit 110 reads the overhead message in the received optical signal to identify the wavelength channel requested for the newly deployed port 220, and notifies the wavelength controller 120 of the identified wavelength channel via signaling line 106. In addition, the port discovery circuit 110 also discovers the attributes associated with the optical port 220 and sends the discovered attributes to the wavelength controller 120, e.g., via signaling line 106. Port discovery circuit 110 may also notify the wavelength selection circuit 130 of the identified wavelength channel, e.g., via signaling line 104.

Wavelength controller 120 associates the identified wavelength channel with the newly deployed optical port 220, and indicates this association to the wavelength selection circuit 130, e.g., via signaling line 108. The wavelength selection circuit 130 routes the wavelength channels to the port discovery circuit 110 or between matching pairs of optical ports 30, 33 as controlled by the wavelength controller 120.

As noted above, each circuit in the hub node 100 performs a specific function towards the identification and rerouting of the new wavelength channel. For example, the port discovery circuit 110 identifies which of the plurality of unallocated wavelength channels comprises the new wavelength channel based on the overhead message, while the wavelength controller 120 associates the new wavelength channel with the newly deployed optical port, and the wavelength selection circuit 130 routes unallocated wavelength channels to the port discovery circuit 110 and reroutes allocated wavelength channel(s) between matching pairs of optical port(s) 220. The following discusses each circuit in detail as each circuit relates to the solution disclosed herein. For simplicity, many operational details associated with each circuit that are irrelevant to the solution disclosed herein are excluded from this discussion.

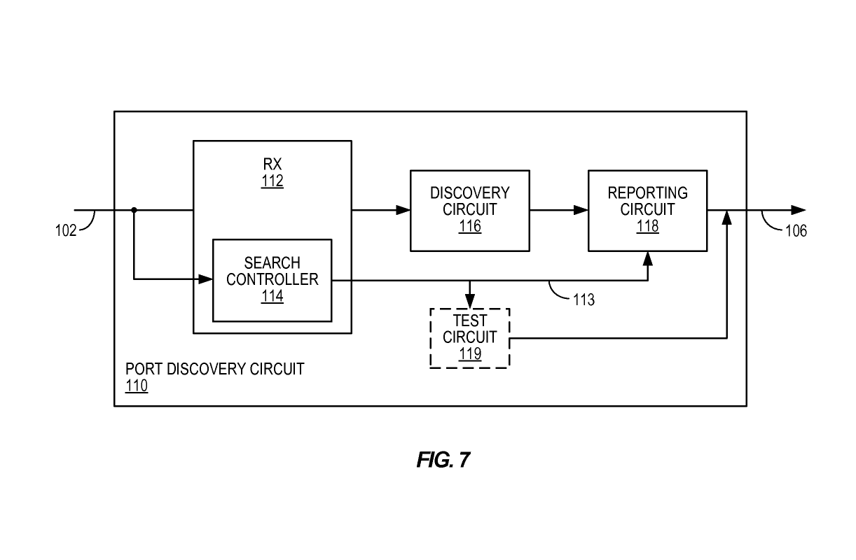

FIG. 7 shows an exemplary block diagram of a port discovery circuit 110 configured to identify which of a plurality of unallocated wavelength channels comprises the new wavelength channel of a newly deployed optical port. To that end, the port discovery circuit 110 comprises at least one receiver 112 comprising a search controller 114, a discovery circuit 116, and a reporting circuit 118. The receiver(s) 112 receive the unallocated wavelength channels via signal line 102 from the wavelength selection circuit 130, and the search controller 114 searches the unallocated wavelength channels for an optical signal. The search controller 114 performs this search by scanning for the presence of an optical signal on the unallocated wavelength channels routed to the port discovery circuit 110, e.g., by detecting an increase in the received power level associated with the unallocated wavelength channels. The search controller 114 identifies which of the unallocated wavelength channel(s) is the new wavelength channel based on an overhead message in the optical signal by, e.g., reading the overhead message. For example, the overhead message may include an integer n, which may be used to identify the nominal center frequency (in THz) of the wavelength channel according to 193.1+0.00625n, where 0.00625 is the nominal central frequency granularity in THz. In this case, the search controller 114 uses n to identify the wavelength channel. In another example, the overhead message may include two integers n and m, where n is as previously defined and the slot width may be determined according to 12.5m, where 12.5 represents the slot granularity in GHz. In this case, the search controller 114 uses n to identify the wavelength channel and uses m to identify the slot width of the wavelength channel. It will be appreciated that the overhead message may use other techniques to identify the wavelength channel.

The discovery circuit 116 discovers one or more attributes of the optical port 220 from the optical signal using any known techniques. The attributes collectively describe or characterize the newly deployed port 220 in terms the capabilities, configuration, and/or use of the port 220. In one or more embodiments, the predefined set of attributes of a new port 220 includes a physical layer protocol used by the port. Additionally or alternatively, the predefined set of attributes of an optical port 220 includes a nominal data rate supported by the optical port 220, a type of service supported by the optical port 220, a line code used by the optical port 220, and/or an error protection (e.g., detecting and/or correcting) code used by the optical port 220. In yet other embodiments, the predefined set of attributes of an optical port 220 additionally or alternatively include a vendor of the remote node 200 at which the optical port 220 is deployed and/or a provider of the service supported by the optical port 220. The port discovery circuit 110 provides the wavelength channel information and the identified attributes associated with the newly deployed optical port 220 to the wavelength controller 120 via, e.g., a reporting circuit 118, on signaling line 106.

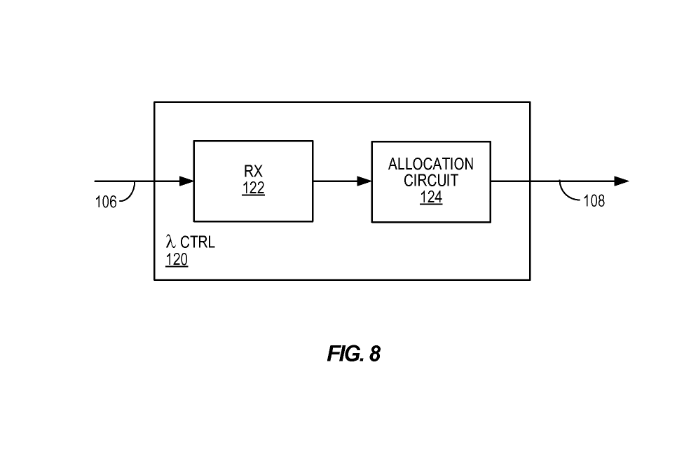

FIG. 8 shows a block diagram of an exemplary wavelength controller 120 comprising a receiver 122 and an allocation circuit 124. Upon receipt of the identified wavelength channel and the attributes from the port discovery circuit 110 at the receiver 122, the allocation circuit 124 determines whether there is a matching pair of optical ports 30, 33 having the same predefined set of attributes according to one or more predefined rules. The predefined rules, for example, specify the extent to which discovered sets of attributes must be the same in order to be considered as matching sets (e.g., whether all attributes in the sets must match, or whether the matching of a certain subset of the attributes suffices for the sets to be considered matching). The predefined rules may also specify conditions for certain attributes themselves to be considered as matching (e.g., whether the attributes must be identical to one another, whether the attributes must be complementary of one another, etc.). Upon discovering a newly deployed client-side port 30, the allocation circuit 124 searches for a matching service-side port 33 that has been previously discovered, or vice versa. If no match is found, the allocation circuit 124 may store or otherwise remember the discovered set of attributes for subsequent matching determinations. If a match is found, however, the allocation circuit 124 dynamically controls the wavelength selection circuit 130 to re-route the wavelength channel providing support for that matching pair.

Upon identifying a matching pair of client-side and service-side optical ports 30, 33, the wavelength controller 120 dynamically controls the wavelength selection circuit 130 to appropriately route the wavelength channels. The wavelength controller 120 may directly control a wavelength selection circuit 130 that is part of the hub node 100 via signaling line 108 as shown in FIG. 6. Alternatively, the wavelength controller may control a remote wavelength selection circuit 130 located remotely from the hub node 100.

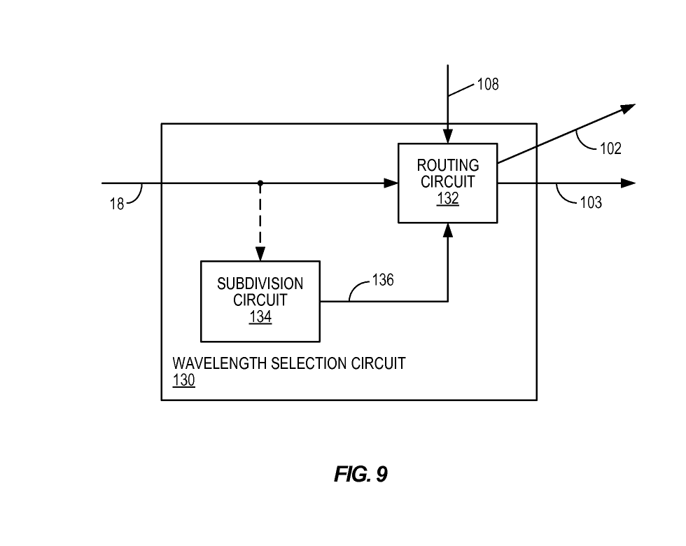

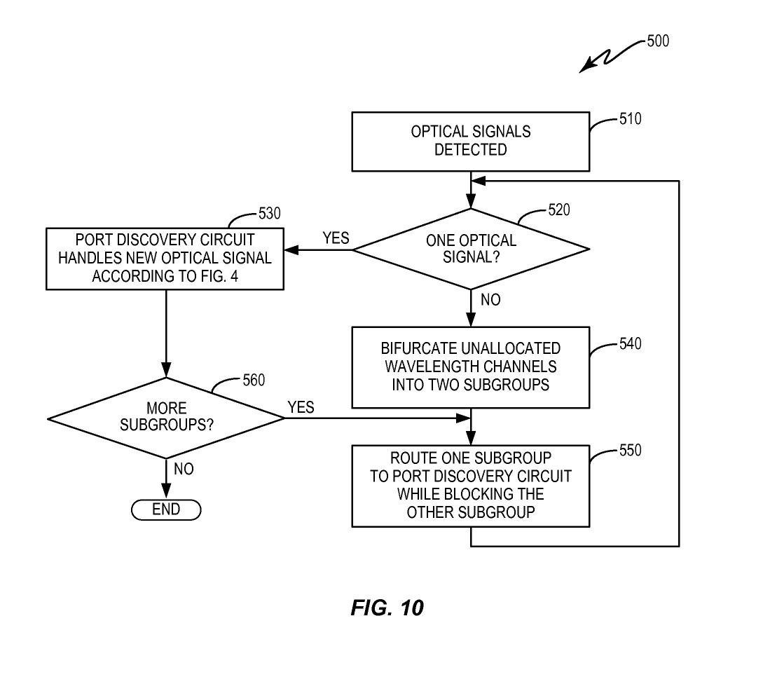

FIG. 9 shows an exemplary block diagram of a wavelength selection circuit 130 comprising a routing circuit 132. Responsive to the control signal from wavelength controller 120, e.g., via signaling line 108, the routing circuit 132 routes all unallocated wavelength channels to the port discovery circuit 110, and routes all allocated wavelength channels associated with matching pairs of ports 30, 33 to the appropriate optical ports 30, 33 via signaling line 103 such that each allocated wavelength channel is available for signal transmissions between the corresponding matching pair of ports 30, 33. More particularly, routing circuit 132 routes any wavelength channel that does not provide support for a matching pair to the port discovery circuit 110. When a new matching pair is discovered, routing circuit 132 controls the wavelength selection circuit 130 to reroute the newly identified wavelength channel from the port discovery circuit 110 between the newly discovered matching pair of ports 30, 33. This way, traffic subsequently transmitted over the identified wavelength channel will be routed between the appropriate optical ports 30, 33 rather than to the port discovery circuit 110.

Consider a simple example shown in the context of FIG. 2 and FIG. 6. Client-side optical port 30B supports wavelength channel 1 (denoted CH1). Port 30B was deployed at client node 20B, discovered by the hub node 100, and determined by the hub node 100 as forming a matching pair with port 33B deployed at service-side node 32B. The routing circuit 132 of the wavelength selection circuit 130 therefore routes CH1 between service-side port 33B and client-side port 30B. Similarly, client-side optical port 30C supports wavelength channel 2 (denoted CH2). Port 30C was previously deployed at client node 20C, discovered by the hub node 100, and determined by the hub node 100 as forming a matching pair with port 33C deployed at service-side node 32C. The routing circuit 132 therefore routes CH2 between service-side port 33C and client-side port 30C. By contrast, wavelength channels 3-8 (denoted CH3-CH8) do not yet provide support for a matching pair of ports, meaning that the routing circuit 132 routes CH3-CH8 to the port discovery circuit 110 via signaling line 102. In an effort to detect a new optical port 220, the port discovery circuit 110 scans these unallocated wavelength channels for the presence of a new optical signal.

Assume now that optical port 33A is newly deployed at service-side node 32A (e.g., by being plugged into that node 32A). Upon such deployment, port 33A begins to transmit an optical signal over CH3. Responsive to detecting the presence of the optical signal on CH3, search controller 114 reads the overhead message in the received optical signal to identify the new wavelength channel, e.g., CH3, associated with the new optical port 33A. Discovery circuit 116 discovers a predefined set of one or more attributes of port 33A by inspecting the optical signal. For example, this discovered set of attributes may include the port being a broadband network gateway (BNG) port that supports a 1 Gigabit data rate for a fixed residential broadband service provided by service provider Y. Responsive to such discovery, the wavelength controller 120 searches for a client-side optical port 30 that has a matching set of attributes. If no such match exists yet, the wavelength controller 120 stores or otherwise remembers the discovered set of attributes for subsequent matching determinations.

Now assume, optical port 30A is later newly deployed at client node 20A (e.g., by being plugged into that client node 20A). Upon such deployment, port 30A begins to transmit an optical signal over CH3. Responsive to detecting the presence of the optical signal on CH3, the search controller 114 reads the overhead message in the optical signal to identify the new wavelength channel, e.g., CH3, associated with the new optical port 30A, and discovery circuit 116 discovers a predefined set of one or more attributes of port 30A by inspecting that optical signal. For example, this predefined set of attributes of port 30A may include the port being a digital subscriber line access multiplexer (DSLAM) port that supports a 1 Gigabit data rate for a fixed residential broadband service provided by service provider Y. Responsive to such discovery, the wavelength controller 120 searches for a service-side optical port 33 that has a matching set of attributes. The allocation circuit 124 in the wavelength controller 120 determines in this regard that client-side port 30A and service-side port 33A form a matching pair, because their discovered sets of attributes match. Indeed, the ports 30A, 33A support the same data rate for the same type of service and for the same service provider, are compatible in terms of being a DSLAM port and a BNG port, etc. The allocation circuit 124 therefore controls the wavelength selection circuit 130, and thus the routing circuit 132, to re-route CH3 from the port discovery circuit 110 between ports 30A and 33A.

In some exemplary embodiments, port discovery circuit 110 includes a test circuit 119 configured to perform a transmission test for the wavelength channel identified by the overhead message, as shown in FIG. 7. During a transmission test, for example, the wavelength controller 120 controls the wavelength selection circuit 130 to route only the identified wavelength channel to the port discovery circuit 110 while temporarily blocking all other unallocated wavelength channels. The test circuit 119 then performs a transmission test for that wavelength channel, e.g., checks if the signal-to-noise ratio associated with the indicated wavelength channel is above a threshold. If the transmission test passes, the port discovery circuit 110 confirms the identified wavelength channel. If the transmission test fails, the hub node 100 may suggest changes to one or more transmission parameters associated with the new optical port 220, e.g., the modulation format, slot width, wavelength channel, error coding, pre-emphasis, laser chirp, polarization, extinction ratio, etc. These suggestions may be implemented by the port discovery circuit 110 and/or the wavelength controller 120. For example, the port discovery circuit 110 may suggest that the optical port 220 change its modulation format to a lower order, or the wavelength controller 120 may suggest that the wavelength selection circuit 130 increase the slot width or tune the newly deployed optical port 220 to a different frequency having less interference from neighboring channels. The port discovery circuit 110 may also optionally communicate with the newly deployed optical port 220 to confirm the identified wavelength channel (when the transmission test passes) or to inform the new optical port 220 of suggested changes to the transmission parameters. For example, the test circuit 119 may write the confirmation or information regarding the suggested changes to the one or more transmission parameters into an Operation, Administration, and Management (OAM) field to inform the new optical port 220 of the transmission parameter changes.

In some exemplary embodiments, the wavelength selection circuit 130 also includes a subdivision circuit 134 to handle scenarios where more than one optical signal is received by the hub node 100, e.g., from more than one newly deployed optical port 220. The receiver 112 in port discovery circuit 110 may determine that multiple optical signals have been received based on a received power level, a decoding error, etc. For example, receiver 112 may determine that an optical signal is present when the received power level exceeds a first threshold, and may determine that multiple optical signals are present when the received power level exceeds a second threshold greater than the first threshold.

When the receiver 112 detects an optical power variation, the receiver 112 knows there is an optical signal present on at least one of the unallocated wavelength channels. The process discussed above discloses how the hub node 100 identifies the wavelength channel associated with the optical signal when there is only one optical signal. If there is more than one optical signal, the multiple optical signals interfere with each other, making it difficult if not impossible for the hub node 100 to read the overhead messages containing the explicit wavelength channel information. To address such situations, the wavelength selection circuit 130 may include a subdivision circuit 134, as shown in FIG. 9. The subdivision circuit 134 subdivides the group of unallocated wavelength channels into multiple subgroups, such that each subgroup of unallocated wavelength channels contains no more than one optical signal. The routing circuit 132 of the wavelength selection circuit 130 separately routes each subgroup to the port discovery circuit 110 while blocking the other subgroups of unallocated wavelength channels, to enable the port discovery circuit 110 to identify the wavelength channel associated with each optical signal as disclosed herein. After the identified wavelength is configured and appropriately routed, the port discovery circuit 110 configures the wavelength selection circuit 130 to route the rest of the unallocated wavelength channels to the port discovery circuit 110 if only one optical signal remains. If more than one optical signal still remains, the wavelength selection circuit 130 repeats the multiple optical signal process for the remaining unallocated wavelength channels. In one embodiment the subdivision circuit 134 repeatedly bifurcates the group of unallocated wavelength channels into subgroups of unallocated wavelength channels, which may in some cases be equal-sized subgroups, until each subgroup contains no more than one optical signal.

FIG. 10 shows an exemplary process 500 for situations when there are multiple optical signals present on the unallocated wavelength channels. Upon detecting the presence of at least one optical signal (block 510) and determining only one optical signal is present (block 520), the hub node 100 handles the new optical signal to identify the wavelength channel of that optical signal as disclosed herein, e.g., as in FIG. 4 (block 530). Upon determining multiple optical signals are present (block 520), the subdivision circuit 134 bifurcates the unallocated wavelength channels into two subgroups (block 540) and routes one subgroup of wavelength channels to the port discovery circuit 110 while blocking the other subgroup of unallocated wavelength channels (block 550). If there is only one optical signal in the subgroup (block 520), control returns to block 530. If there are still multiple optical signals in that subgroup (block 520), control returns to block 540 and the bifurcation process repeats until the selection circuit 114 has a subgroup of unallocated wavelength channels with only one optical signal. If more subgroups remain (block 560) after the port discovery circuit 110 discovers the new optical port (block 530), control returns to block 550 where the wavelength selection circuit 130 routes one of the remaining subgroups to port discovery circuit 110 while block the rest of the subgroups.

For example, assume there are eight unallocated wavelength channels (e.g., CH1-CH8), and that an optical signal is present on each of CH3 and CH6. After the receiver 112 determines there is more than one optical signal present, subdivision circuit 134 bifurcates the original group of four unallocated wavelength channels into two groups: Subgroup A containing CH1- and CH4, and Subgroup B containing CH5-CH8. The routing circuit 132 then routes the unallocated wavelength channels of Subgroup A to the port discovery circuit 110 while blocking the unallocated wavelength channels of Subgroup B. Because there is now only one optical signal present in Subgroup A, the search controller 114 is able to read the overhead message of the optical signal in Subgroup A and identify the wavelength channel, e.g., CH3, as disclosed herein. Subsequently, routing circuit 132 routes the unallocated wavelength channels of Subgroup B to the port discovery circuit 110 while blocking the unallocated wavelength channels of Subgroup A. Because there is now only one optical signal present Subgroup B, the search controller 114 is able to read the overhead message of the optical signal in Subgroup B and identify the wavelength channel, e.g., CH6.

Consider another example where there are eight unallocated wavelength channels (e.g., CH1-CH8), and that an optical signal is present on each of CH1 and CH3. After the receiver 112 determines there is more than one optical signals present, the subdivision circuit 134 bifurcates the original group of four unallocated wavelength channels into two groups: Subgroup A containing CH1-CH4, and Subgroup B containing CH5-CH8. The routing circuit 132 then routes the unallocated wavelength channels of Subgroup A to the port discovery circuit 110 while blocking the unallocated wavelength channels of Subgroup B. Because there are still two optical signals present in Subgroup A, the search controller 114 still cannot read the overhead messages. Thus, the subdivision circuit 134 further bifurcates Subgroup A into Subgroup A1 containing CH1-CH2 and Subgroup A2 containing CH3-CH4. The routing circuit 132 then routes the unallocated wavelength channels of Subgroup A1 to the port discovery circuit 110 while blocking the unallocated wavelength channels of Subgroups A1 and B. Because there is now only one optical signal present in Subgroup A1, the search controller 114 is able to read the overhead message of the optical signal in Subgroup A1 and identify the wavelength channel, e.g., CH1, as disclosed herein. Subsequently, routing circuit 132 routes the remaining unallocated wavelength channels of Subgroups A2 and B to the port discovery circuit 110. Because there is now only one optical signal present in the unallocated wavelength channels, the search controller 114 is able to read the overhead message of the optical signal in Subgroup A2 and identify the wavelength channel, e.g., CH3, as disclosed herein.

The solution disclosed herein substantially reduces the total time required to reroute wavelength channels between newly deployed optical port(s). For example, when only one optical signal is present, the wavelength selection circuit 130 can block a wavelength channel associated with a newly deployed optical port 220 receiving new optical signals associated with other optical ports within 100 ms of the hub circuit 100 determining the new optical port 220 has been deployed. This is a savings of 100 mx per cycle relative to prior art solutions. When multiple optical signals, the wavelength selection circuit 130 only needs three configuration cycles, each of which are 100 ms long, to locate CH1, for example. Consider the example where a finely tuned laser provides 100 possible wavelength channels, e.g., spaced by 25 GHz. In this case, the solution disclosed herein can reduce the average time needed to discover the wavelength channel of a newly deployed optical port to 1 second, which is a significant improvement over the 400 seconds required on average for some prior art solutions.

Various elements of the hub node 100 and remote node 200 disclosed herein are described as some kind of circuit. Each of these circuits may be embodied in hardware and/or in software (including firmware, resident software, microcode, etc.) executed on a controller or processor, including an application specific integrated circuit (ASIC).

It is possible that there are services carried other than Ethernet in MetNet, e.g., OTN or CPRI. In this case, the remote node 200 will write the wavelength information in an overhead message of a packet according to the underlying protocol, and the port discovery circuit 110 should be enhanced by adding modules that are able to read the corresponding overhead messages.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A hub node in a wavelength division multiplexed (WDM) optical network configured to identify a new wavelength channel associated with a new optical port at a remote node, the hub node comprising:
a port discovery circuit configured to discover the new optical port and the associated new wavelength channel, the port discovery circuit comprising:
at least one receiver configured to receive an optical signal from the remote node, wherein the optical signal includes an overhead message identifying the new wavelength channel associated with the new optical port,
the receiver including a search controller configured to identify which of a plurality of unallocated wavelength channels comprises the new wavelength channel based on the overhead message; and
a wavelength controller configured to associate wavelength channels with the corresponding optical ports, the wavelength controller comprising:
a receiver configured to receive an indication of the new wavelength channel from the port discovery circuit; and
an allocation circuit configured to associate the new wavelength channel with the new optical port.

2. The hub node of claim 1 wherein the overhead message is comprised in an Operation, Administration, and Management (OAM) field associated with a communications protocol.

3. The hub node of claim 1 wherein the overhead message comprises a first integer, and wherein the search controller is configured to identify which of the plurality of unallocated wavelength channels comprises the new wavelength channel based on the first integer.

4. The hub node of claim 3 wherein the overhead message further comprises a second integer, and wherein the search controller is further configured to identify a slot width of the wavelength channel based on the second integer.

5. The hub node of claim 1 wherein the port discovery circuit further comprises a test circuit configured to:
perform a transmission test for the new wavelength channel based on one or more test parameters; and
if the transmission test fails, suggest changes to one or more transmission parameters associated with the new optical port.

6. The hub node of claim 5 wherein the test circuit is further configured to write information regarding the suggested changes to the one or more transmission parameters into an Operation, Administration, and Management (OAM) field to inform the new optical port of the suggested changes to the one or more transmission parameters.

7. The hub node of claim 1 further comprising a wavelength selection circuit comprising a routing circuit configured to:
route any allocated wavelength channel to the corresponding optical port; and
route the unallocated wavelength channels to the port discovery circuit.

8. The hub node of claim 7 wherein:
the wavelength selection circuit further comprises a subdivision circuit configured to subdivide the plurality of unallocated wavelength channels into two or more subgroups of unallocated wavelength channels when the hub node detects that the at least one receiver received more than one optical signal such that each subgroup of unallocated wavelength channels includes no more than one optical signal;
the routing circuit is further configured to route the unallocated wavelength channels associated with a first subgroup of unallocated wavelength channels that includes one first optical signal to the port discovery circuit while blocking the unallocated wavelength channels of the remaining one or more subgroups of unallocated wavelength channels; and
the search controller is configured to identify which of the unallocated wavelength channels in the first subgroup of wavelength channels comprises the new wavelength channel based on the overhead message included in the one first optical signal.

9. The hub node of claim 8 wherein:
the subdivision circuit is further configured to unblock the unallocated wavelength channels of the remaining one or more subgroups of wavelength channels; and
the routing circuit is further configured to route the unallocated wavelength channels associated with a subsequent subgroup of wavelength channels that includes one subsequent optical signal to the port discovery circuit while blocking the unallocated wavelength channels of any remaining subgroups of wavelength channels.

10. The hub node of claim 8 wherein the subdivision circuit is configured to subdivide the plurality of unallocated wavelength channels into two or more equal-sized subgroups of unallocated wavelength channels when the hub node detects more than one optical signal such that each equal-sized subgroup of wavelength channels includes no more than one optical signal.

11. The hub node of claim 8 wherein the hub node detects that the at least one receiver received more than one optical signal based on a received power level.

12. The hub node of claim 1 wherein the hub node detects that the at least one receiver received more than one optical signal based on a decoding error.

13. The hub node of claim 1 wherein the port discovery circuit receives the unallocated wavelength channels from a remote wavelength selection circuit.

14. The hub node of claim 13 wherein:
the port discovery circuit receives a subgroup of unallocated wavelength channels from the remote wavelength selection circuit when the hub node detects more than one optical signal, said subgroup containing less than the total number of unallocated wavelength channels;
the subgroup of unallocated wavelength channels includes no more than one optical signal;
any remaining unallocated wavelength channels are blocked from the port discovery circuit; and
the search controller is configured to identify which of the unallocated wavelength channels in the subgroup of unallocated wavelength channels comprises the new wavelength channel based on the overhead message included in the one optical signal associated with the subgroup.

15. A method, executed in a hub node of a wavelength division multiplexed (WDM) optical network, of identifying a new wavelength channel associated with a new optical port at a remote node, the method comprising:
receiving an optical signal from the remote node, the optical signal including an overhead message identifying the new wavelength channel associated with the new optical port;
identifying which of a plurality of unallocated wavelength channels comprises the new wavelength channel based on the overhead message; and
associating the new wavelength channel with the new optical port.

16. The method of claim 15 wherein the overhead message is comprised in an Operation, Administration, and Management (OAM) field associated with a communications protocol.

17. The method of claim 15 wherein the overhead message comprises a first integer, and wherein identifying which of the plurality of unallocated wavelength channels comprises the new wavelength channel comprises identifying which of the plurality of unallocated wavelength channels comprises the new wavelength channel based on the first integer.

18. The method of claim 17 wherein the overhead message further comprises a second integer, the method further comprising identifying a slot width of the wavelength channel based on the second integer.

19. The method of claim 15 further comprising:
performing a transmission test for the new wavelength channel based on one or more test parameters provided by the port discovery circuit; and
if the transmission test fails, suggesting changes to one or more transmission parameters associated with the new optical port.

20. The method claim 19 further comprising writing information regarding the suggested changes to the one or more transmission parameters into an Operation, Administration, and Management (OAM) field to inform the new optical port of the suggested changes to the one or more transmission parameters.

21. The method of claim 15 further comprising:
routing any allocated wavelength channel to the corresponding optical port; and
routing the unallocated wavelength channels to a port discovery circuit in the hub node.

22. The method of claim 21 wherein routing the unallocated wavelength channels to the port discovery circuit comprises:
subdividing the plurality of unallocated wavelength channels into two or more subgroups of wavelength channels when the hub node detects more than one optical signal such that each subgroup of wavelength channels includes no more than one optical signal; and
routing the unallocated wavelength channels associated with a first subgroup of wavelength channels that includes one first optical signal to the port discovery circuit while blocking the unallocated wavelength channels of the remaining one or more subgroups of wavelength channels.

23. The method of claim 22 wherein identifying which of the plurality of unallocated wavelength channels comprises the new wavelength channel comprises identifying which of the unallocated wavelength channels in the first subgroup of wavelength channels comprises the new wavelength channel based on the overhead message included in the one first optical signal.

24. The method of claim 22 wherein routing the unallocated wavelength channels to the port discovery circuit further comprises:
unblocking the unallocated wavelength channels of the remaining one or more subgroups of wavelength channels; and
routing the unallocated wavelength channels associated with a subsequent subgroup of wavelength channels that includes one subsequent optical signal to the port discovery circuit while blocking the unallocated wavelength channels of any remaining subgroups of wavelength channels.

25. The method of claim 22 wherein subdividing the plurality of unallocated wavelength channels into two or more subgroups of wavelength channels comprises subdividing the plurality of unallocated wavelength channels into two or more equal-sized subgroups of unallocated wavelength channels when the hub node detects more than one optical signal such that each equal-sized subgroup of wavelength channels includes no more than one optical signal.

26. The method of claim 15 further comprising receiving the unallocated wavelength channels from a remote wavelength selection circuit.

27. The method claim 26 wherein:
receiving the unallocated wavelength channels comprises receiving a subgroup of the unallocated wavelength channels from the remote wavelength selection circuit when the hub node detects more than one optical signal, wherein the subgroup contains less than the total number of unallocated wavelength channels and includes no more than one optical signal, and wherein any remaining unallocated wavelength channels are blocked from the port discovery circuit; and
identifying which of the plurality of unallocated wavelength channels comprises the new wavelength channel comprises identifying which of the unallocated wavelength channels in the subgroup of unallocated wavelength channels comprises the new wavelength channel based on the overhead message included in the one optical signal associated with the subgroup.

28. The method of claim 15 further comprising detecting that the hub node has received more than one optical signal based on a received power level.

29. The method of claim 15 further comprising detecting that the hub node has received more than one optical signal based on a decoding error.

30. A remote node configured for connection to a hub node in a wavelength division multiplexed (WDM) optical network, the remote node 200 comprising:
a packet header circuit configured to write wavelength information associated with a requested wavelength channel of the WDM optical network into an overhead message of a packet carried by an optical signal; and
an optical port configured to send the optical signal including the overhead message to the hub node to explicitly identify the requested wavelength channel to the hub node.

31. A method, executed in a remote node configured for connection to a hub node in a wavelength division multiplexed (WDM) optical network, the method comprising:
writing wavelength information associated with a requested wavelength channel of the WDM optical network into an overhead message of an optical signal; and
sending the optical signal including the overhead message to the hub node from an optical port of the remote node to explicitly identify the requested wavelength channel to the hub node.
